(19) United States
(12) Patent Application Publication
(10) Pub. No.: US 2021/0241356 A1
(43) Pub. Date: Aug. 5, 2021

(54) INFORMATION PROCESSING APPARATUS, CONTROL METHOD, AND PROGRAM

(71) Applicant: NEC PLATFORMS, LTD., Kanagawa (JP)

(72) Inventor: Reo MASUDA, Kawasaki-shi (JP)

(73) Assignee: NEC Platforms, Ltd., Kanagawa (JP)

(21) Appl. No.: 17/052,909

(22) PCT Filed: Apr. 22, 2019
(86) PCT No.: PCT/JP2019/017073

§ 371 Date: Nov. 4, 2020

(30) Foreign Application Priority Data
May 21, 2018 (JP) 2018-096856

(51) Int. Cl. G06Q 30/06; G06N 5/04; G06F 3/0481; G06K 9/62; G06K 9/00

(52) U.S. Cl. CPC G06Q 30/0635; G06N 5/04; G06Q 20/208; G06K 9/6215; G06K 9/00362; G06F 3/04812

(57) ABSTRACT

A product registration apparatus (10) is an apparatus which is operated for a product registration work of registering a product as a settlement target. A display apparatus (20) is provided in the product registration apparatus (10). A plurality of selection images (30) are displayed on the display apparatus (20). When a selection image (30) is operated, a product corresponding to the selection image (30) is registered as the settlement target. An information processing apparatus (2000) generates, for each customer, information (inference information) indicating a product inferred to be purchased by the customer. The inference information is generated based on a behavior of each of a plurality of customers. The inference information generated for a customer indicates identification information of the customer and identification information of the product inferred to be purchased by the customer in association with each other. The information processing apparatus (2000) uses a plurality of pieces of inference information to control the display of the selection images (30) on the display apparatus (20) used for the product registration work for the customer.

### TECHNICAL FIELD

The present invention relates to a technology of registering a product as a settlement target.

### BACKGROUND ART

In a store such as a supermarket or a convenience store, a so-called cashier terminal performs a work of registering a product to be purchased by a customer as a settlement target (hereinafter, a product registration work). By paying for (settling) the registered product, the customer purchases the product.

A technology is developed to assist the product registration work described above. For example, Patent Document 1 discloses a technology of assisting a registration work by using information on a flow line of a customer in a store. A point of sales (POS) terminal apparatus used for registering a product recognizes the product by using an image of the product to be registered. The recognition of the product is performed by identifying the product to be recognized by matching feature data of the product extracted from the image with a reference image of each product. At this time, the reference image to be matched is narrowed down by using information on the flow line of the customer. Specifically, when performing a product registration work on a product to be purchased by a customer, each product displayed at a position matching a flow line of the customer is identified, and a reference image of each identified product is used for matching.

### RELATED DOCUMENT

### Patent Document

[Patent Document 1] International Publication No. 2015/140853

### SUMMARY OF THE INVENTION

### Technical Problem

The product on the flow line of the customer is not always a product which is likely to be purchased by the customer. Therefore, the present inventor invents a new technology for inferring a product which is likely to be purchased by a customer. An object of the present invention is to provide a new technology that assists a work of registering a product as a settlement target.

### Solution to Problem

According to the present invention, there is provided an information processing apparatus including: 1) a generation unit that generates, based on a behavior of each of a plurality of customers, inference information in which identification information of the customer and identification information of a product inferred to be purchased by the customer are associated with each other; and 2) a display control unit that displays selection information for registering the product as a settlement target on a display apparatus used for a product registration work of registering the product purchased by a target customer as the settlement target, by using a plurality of pieces of the inference information.

According to the present invention, there is provided a control method executed by a computer. The control method includes 1) a generation step of generating, based on a behavior of each of a plurality of customers, inference information in which identification information of the customer and identification information of a product inferred to be purchased by the customer are associated with each other; and 2) a display control step of displaying selection information for registering the product as a settlement target on a display apparatus used for a product registration work of registering the product purchased by a target customer as the settlement target, by using a plurality of pieces of the inference information.

According to the present invention, there is provided a program causing a computer to execute each step of the control method according to the present invention.

### Advantageous Effects of Invention

According to the present invention, a new technology is provided which assists a work of registering a product as a settlement target.

### BRIEF DESCRIPTION OF THE DRAWINGS

The above objects and other objects, features and advantages will become more apparent from the following description of the preferred example embodiments and the accompanying drawings.

FIG. 1 is a diagram for explaining an outline of an operation of an information processing apparatus according to Example Embodiment 1.

FIG. 2 is a diagram illustrating a functional configuration of the information processing apparatus according to Example Embodiment 1.

FIG. 3 is a diagram illustrating a computer for realizing the information processing apparatus.

FIG. 4 is a flowchart illustrating a flow of a process executed by the information processing apparatus according to Example Embodiment 1.

FIG. 5 is a diagram illustrating a structure of inference information.

FIG. 6 is a diagram illustrating a situation in which a first camera is installed at an entrance of a store.

FIG. 7 is a diagram illustrating a situation in which four first cameras are installed at the entrance of the store.

FIG. 8 is a diagram illustrating inference information indicating a plurality of pieces of customer identification information.

FIG. 9 is a diagram illustrating a situation in which a second camera is installed at a display place of a product.

FIG. 10 is a diagram illustrating inference information indicating product identification information of a product returned to a display place.

FIG. 11 is a diagram illustrating a priority of each display position defined by layout information.

FIG. 12 is a diagram illustrating a third camera installed near a product registration apparatus.

FIG. 13 is a diagram illustrating an evaluation value of a product computed by using a similarity of customer identification information.

FIG. 14 illustrates a case where inference information includes return information in the example illustrated in FIG. 13.

FIG. 15 is a diagram illustrating a fourth camera which images a product to be registered by a product registration work.

FIG. 16 is a diagram illustrating an evaluation value computed by using a captured image generated by a fourth camera.

FIG. 17 is a diagram illustrating an RFID reader installed near the product registration apparatus.

FIG. 18 is a diagram illustrating a method of determining an evaluation value by using the RFID reader.

FIG. 19 is a diagram illustrating a total evaluation value computed by adding up from a first evaluation value to a third evaluation value.

FIG. 20 is a diagram illustrating display of a selection image controlled based on the total evaluation value illustrated in FIG. 19.

FIG. 21 is a first diagram illustrating an example of narrowing down candidates for a target customer based on progress of a product registration work for the target customer.

FIG. 22 is a second diagram illustrating an example of narrowing down candidates for a target customer based on progress of a product registration work for the target customer.

FIG. 23 is a diagram illustrating an example of narrowing down candidates for a target customer based on progress of a product registration work for a customer other than the target customer.

FIG. 24 is a third diagram illustrating a situation in which a plurality of cashier counters are included, in a recognition range of an RFID reader.

FIG. 25 is a diagram illustrating a method in which the information processing apparatus according to Example Embodiment 3 corrects an evaluation value.

### DESCRIPTION OF EMBODIMENTS

Hereinafter, example embodiments according to the present invention will be described by using the drawings. In all of the drawings, the same components are denoted by the same reference numerals, and description thereof will not be repeated as appropriate. In addition, unless otherwise described, in each of block diagrams, each of blocks represents not a hardware unit but a functional unit configuration.

### Example Embodiment 1

<Outline>

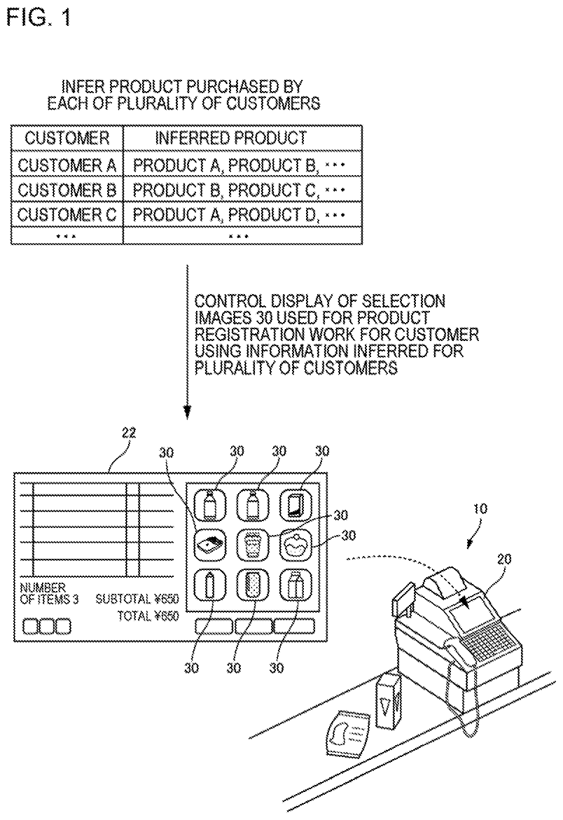

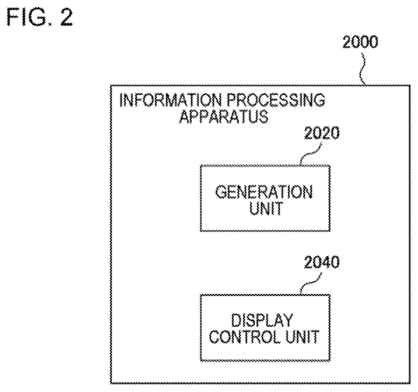

FIG. 1 is a diagram for explaining an outline of an operation of an information processing apparatus (an information processing apparatus 2000 in FIG. 2 to be described below) according to Example Embodiment 1. The operation of the information processing apparatus 2000 to be described below is an example for facilitating understanding of the information processing apparatus 2000, and the operation of the information processing apparatus 2000 is not limited to the following example. Details or variations of the operation of the information processing apparatus 2000 will be described below.

The information processing apparatus 2000 is used in a store for a work of registering a product as a settlement target. In a case where a customer purchases a product at a store, a work of registering the product purchased by the customer as a settlement target (hereinafter, a product registration work) is performed. For example, the product registration work is a work of reading a barcode attached to the product by using a barcode reader. When all products which the customer intends to purchase are registered as settlement targets, the customer uses cash or a credit card to pay (settle) the price.

Hereinafter, an apparatus operated by a store clerk or the like for the product registration work (for example, a terminal in which the barcode reader described above is installed) is referred to as a product registration apparatus. The product registration apparatus is also called, for example, a cashier terminal. In FIG. 1, the product registration apparatus is represented by reference numeral 10. Note that, a product registration apparatus 10 may be operated by a store clerk or a customer.

In the present example embodiment, one of methods of registering a product as a settlement target includes a method of operating selection information displayed on a display apparatus. The selection information is information used for an input operation for registering a product as a settlement target. For example, the selection information is an image of a product, a character string representing a name of the product, or the like. In the following description, a selection image which is an image of a product is used as an example of the selection information. In FIG. 1, a display apparatus 20 is provided in the product registration apparatus 10. The display apparatus 20 has a touch panel 22. A plurality of selection images 30 are displayed on the touch panel 22. The selection image 30 is an example of the selection information. When a selection image 30 is operated (for example, touched), a product corresponding to the selection image 30 is registered as a settlement target. For example, when the selection image 30 representing a tea A is touched, a product of the tea A is registered as the settlement target.

The information processing apparatus 2000 according to the present example embodiment controls display of the selection image 30 on the display apparatus 20. For example, the information processing apparatus 2000 determines which product selection image 30 is to be displayed on the display apparatus 20 among products sold in the store, and causes the display apparatus 20 to display the selection image 30 of each determined product. In addition, for example, the information processing apparatus 2000 determines a layout of the plurality of selection images 30 to be displayed on the display apparatus 20.

In order to control the display of the selection image 30 on the display apparatus 20, the information processing apparatus 2000 generates, for each customer, information (hereinafter, inference information) indicating a product inferred to be purchased by the customer. The inference information is generated based on a behavior of each of a plurality of customers. The inference information generated for a customer indicates identification information of the customer and identification information of the product inferred to be purchased by the customer in association with each other.

The information processing apparatus 2000 uses a plurality of pieces of inference information to control the display of the selection image 30 on the display apparatus 20 used for the product registration work for the customer. Hereinafter, the customer who is a target of a process of the information processing apparatus 2000 is referred to as a target customer. In other words, in a case where the information processing apparatus 2000 controls the display of the selection image 30 on the display apparatus 20 used for the product registration work for a customer, this customer is called the target customer.

Note that, the store at which the information processing apparatus 2000 is used is any place at which customers can purchase products. For example, the store is a supermarket or a convenience store. Note that, the store does not necessarily have to be set up indoors, and may be set out outdoors.

### Advantageous Effect

With the information processing apparatus 2000 according to the present example embodiment, when a product registration work is performed for a customer, the selection image 30 used for selecting a product to be registered is displayed on the display apparatus 20 used for the product registration work. Here, the information processing apparatus 2000 generates, for each of the plurality of customers, inference information indicating the product inferred to be purchased by the customer. The information processing apparatus 2000 controls the display of the selection image 30 on the display apparatus 20 by using not only the inference information of a target customer who is a target of the product registration work but also the inference information of the other customers.

According to the method of using the inference information generated for each of the plurality of customers in this manner, a risk of omissions in candidates for the product registered as the settlement target is reduced, as compared with the case where only information generated for the target customer is focused on. Therefore, it is possible to prevent inconvenience that efficiency of the product registration work is lowered since the product to be registered is not mistakenly included in the candidates.

Hereinafter, the present example embodiment will be described in more detail.

<Example of Functional Configuration of Information Processing Apparatus 2000>

FIG. 2 is a diagram illustrating a functional configuration of the information processing apparatus 2000 according to Example Embodiment 1. The information processing apparatus 2000 includes a generation unit 2020 and a display control unit 2040. The generation unit 2020 generates inference information for each customer based on a behavior of each of a plurality of customers. The display control unit 2040 uses a plurality of pieces of inference information to display the selection image 30 on the display apparatus 20 used for a product registration work for a target customer.

<Hardware Configuration of Information Processing Apparatus 2000>

Each of functional configuration units of the information processing apparatus 2000 may be realized by hardware (for example, hard-wired electronic circuit or the like) which realizes each of the functional configuration units or may be realized by a combination (for example, a combination of the electronic circuit and a program controlling the electronic circuit or the like) of hardware and software. Hereinafter, a case where each of the functional configuration units in the information processing apparatus 2000 is realized by a combination of hardware and software will be further described.

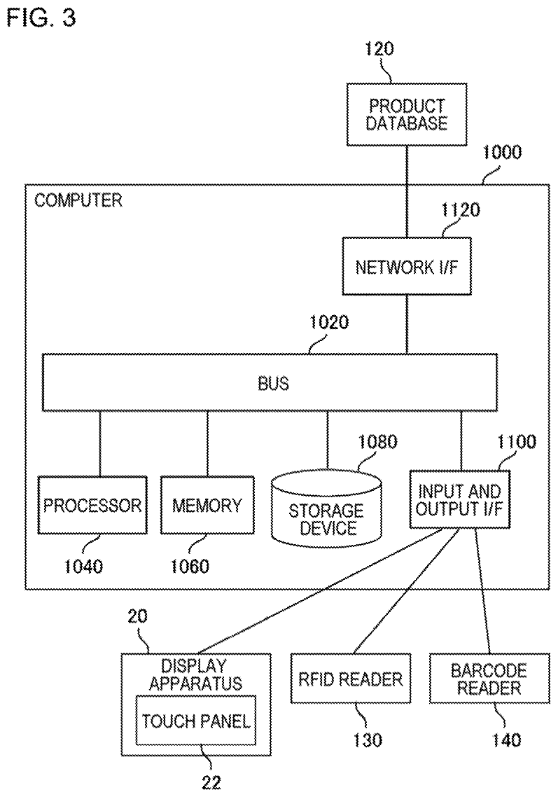

FIG. 3 is a diagram illustrating a computer 1000 for realizing the information processing apparatus 2000. The computer 1000 is any computer. For example, the computer 1000 is a personal computer (PC), a server machine, a tablet terminal, a smartphone, or the like. The computer 1000 may be a dedicated computer designed to realize the information processing apparatus 2000 or may be a general purpose computer.

For example, the information processing apparatus 2000 is the product registration apparatus 10 in which the display apparatus 20 to be controlled is installed. However, the information processing apparatus 2000 may be any apparatus which can control the display apparatus 20, and is not necessarily the product registration apparatus 10.

The computer 1000 includes a bus 1020, a processor 1040, a memory 1060, a storage device 1080, an input and output interface 1100, and a network interface 1120. The bus 1020 is a data transmission line through which the processor 1040, the memory 1060, the storage device 1080, the input and output interface 1100, and the network interface 1120 mutually transmit and receive data. Meanwhile, a method of connecting the processor 1040 and the like to each other is not limited to bus connection. The processor 1040 is various processors such as a central processing unit (CPU), a graphics processing unit (GPU), or the like. The memory 1060 is a main storage realized by using a random access memory (RAM) or the like. The storage device 1080 is an auxiliary storage realized by using a hard disk, a solid state drive (SSD), a memory card, a read only memory (ROM), or the like. Meanwhile, the storage device 1080 may be configured with the same hardware as the hardware constituting the main storage such as a RAM.

The input and output interface 1100 is an interface for connecting the computer 1000 and an input and output device. For example, the display apparatus 20 is connected to the input and output interface 1100. In addition, for example, the input and output interface 1100 may be connected to various types of hardware used for the product registration work. For example, a bar code reader or a radio frequency identifier (RFID) reader is connected for the product registration work.

The network interface 1120 is an interface for connecting the computer 1000 to a network. The communication network is, for example, a local area network (LAN) or a wide area network (WAN). A method by which the network interface 1120 connects to the network may be a wireless connection or a wired connection. For example, the information processing apparatus 2000 is connected via the network to a database server (hereinafter, a product database 120) which manages product information.

The storage device 1080 stores a program module which realizes each functional configuration unit of the information processing apparatus 2000. By reading each of these program modules into the memory 1060 and executing the program module, the processor 1040 realizes a function corresponding to each of the program modules. In addition, for example, the storage device 1080 stores inference information. However, a storage unit which stores the inference information may be provided outside the information processing apparatus 2000.

<Flow of Process>

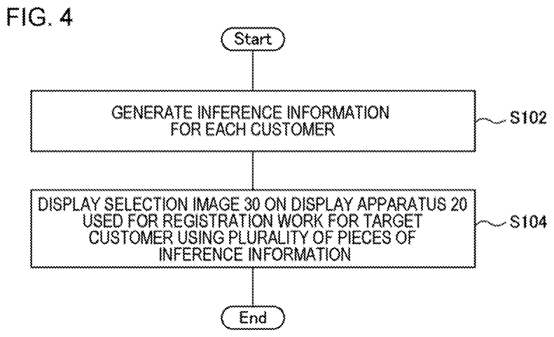

FIG. 4 is a flowchart illustrating a flow of a process executed by the information processing apparatus 2000 according to Example Embodiment 1. The generation unit 2020 generates inference information for each of a plurality of customers (S102). The display control unit 2040 uses a plurality of pieces of inference information to display the selection image 30 on the display apparatus 20 used for a product registration work for a target customer (S104).

<Generation of Inference Information in S102>

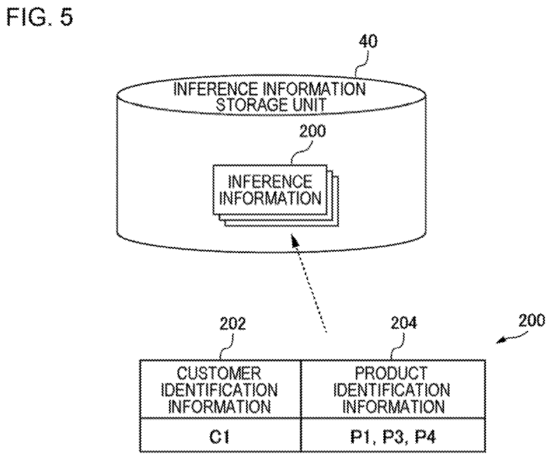

The generation unit 2020 generates inference information for each customer (S102). FIG. 5 is a diagram illustrating a structure of inference information. In FIG. 5, an inference information storage unit 40 stores inference information 200 for each customer. In the inference information 200, product identification information 204 is associated with customer identification information 202.

The customer identification information 202 indicates customer identification information which is information for identifying each customer. The customer identification information is, for example, a feature value of an appearance of the customer (hereinafter, a feature value of the customer) obtained by analyzing a captured image. The feature value of the customer represents, for example, at least one or more of a feature of the customer viewed from any one or more directions (a front side, a back side, or the like) and a feature of an object which the customer carries. Here, an existing technology can be used as a technology for computing the feature value representing these features from the captured image.

The product identification information 204 indicates the product identification information of each product associated with the customer identification information indicated in the customer identification information 202. The product identification information is information (for example, an identification number) for identifying each product. The product identification information of each product is managed in the product database 120.

The inference information 200 is generated by using a captured image generated by capturing an image of a customer with a camera. For example, the generation unit 2020 generates the inference information 200 according to the following flow.

The generation unit 2020 newly generates the inference information 200 for a customer who newly visited a store. The new inference information 200 generated for a customer is inference information 200 in which the customer identification information 202 indicates customer identification information of the customer, and the product identification information 204 associated with the customer identification information 202 is empty.

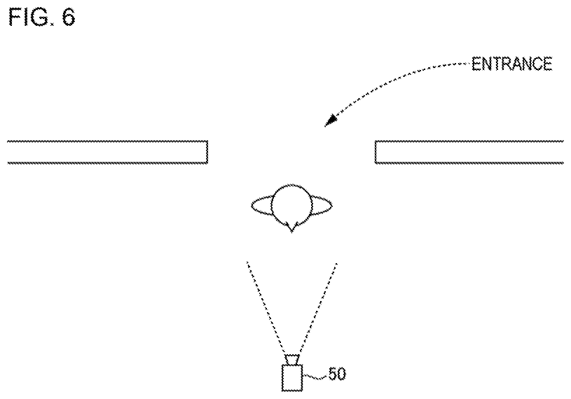

For that purpose, the generation unit 202 acquires the captured image generated by the camera (hereinafter, referred to as a first camera) installed at a predetermined position in the store. The predetermined position at which the first camera is installed is, for example, an entrance of the store. FIG. 6 is a diagram illustrating a state in which a first camera 50 is installed at an entrance of a store.

The generation unit 2020 detects the customer from the captured image by performing a person detection process on the captured image generated by the first camera. Further, the generation unit 2020 computes a feature value of the customer by using the captured image in which the customer is detected.

The generation unit 2020 determines whether or not the inference information 200 on the detected customer is already generated. Specifically, the generation unit 2020 determines whether or not the inference information 200 regarding the detected customer is stored in the inference information storage unit 40.

In a case where the inference information 200 regarding the detected customer is not stored in the inference information storage unit 40, the generation unit 2020 generates new inference information 200 regarding the detected customer. Specifically, the generation unit 2020 generates the inference information 200, in which a feature value of the detected customer is indicated in the customer identification information 202 and the product identification information 204 is empty. The generation unit 2020 stores the generated inference information 200 in the inference information storage unit 40.

Note that, it is possible to determine whether or not the inference information 200 is the inference information 200 on the detected customer by comparing customer identification information indicated by the inference information 200 with customer identification information (the feature value of the customer) computed from the captured image in which the customer is detected. For example, in a case where a similarity between the customer identification information indicated by the inference information 200 and the customer identification information computed from the captured image in which the customer is detected is equal to or more than a predetermined value, it is determined that the inference information 200 is the inference information 200 on the detected customer. On the other hand, in a case where a similarity between the customer identification information indicated by the inference information 200 and the customer identification information computed from the captured image in which the customer is detected is less than the predetermined value, it is determined that the inference information 200 is not the inference information 200 on the detected customer.

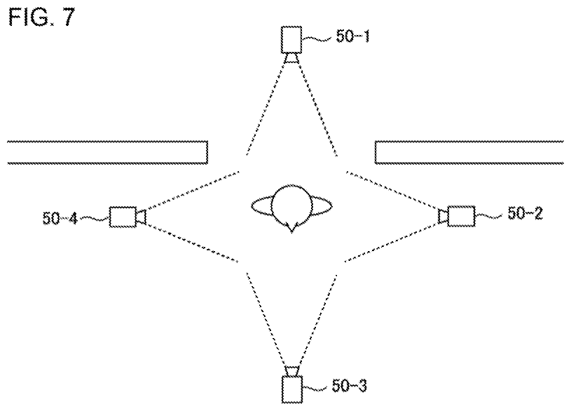

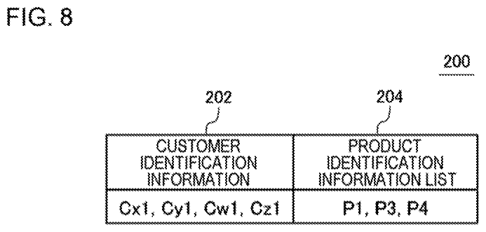

Here, the inference information 200 may indicate a plurality of pieces of customer identification information. For example, a plurality of first cameras 50 capturing the customer at different angles are installed in advance, and the plurality of pieces of customer identification information can be generated for one customer by using captured images generated by the respective first camera 50. For example, for one customer, feature values in four directions of a front side, a left side, a right side, and a rear side are computed. FIG. 7 is a diagram illustrating a situation in which the four first cameras 50 are installed at the entrance of the store. FIG. 8 is a diagram illustrating the inference information 200 indicating a plurality of pieces of customer identification information on one customer. The plurality of pieces of customer identification information for one customer includes a feature value of the customer's face, a feature value of the customer's clothes, a feature value of the customer's belongings, and the like.

Note that, a plurality of customer feature values for one customer may be computed from one captured image. For example, the feature value of the customer's face, the feature value of the customer's clothes, the feature value of the customer's belongings, and the like can be computed from one captured image in which the customer is included.

«Detection of Product Taken out from Display Place»

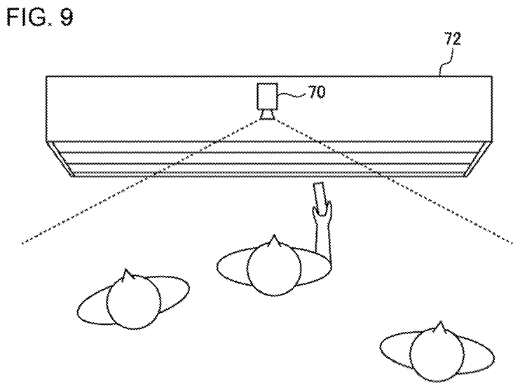

The generation unit 2020 adds product identification information of a product inferred to be purchased by a customer relating to the inference information 200, to the inference information 200 stored in the inference information storage unit 40. This process is performed by, for example, performing image analysis on a captured image generated by a camera (hereinafter, referred to as a second camera) installed so as to image a display place of the product. FIG. 9 is a diagram illustrating a situation in which a second camera 70 is installed at a display place of a product. In FIG. 9, the second camera 70 is installed above a product shelf 72. Note that, the second camera 70 is installed in each of a plurality of product shelf units 72.

First, the generation unit 2020 detects that the product is taken out from the display place by performing image analysis on the captured image generated by the second camera 70. This detection is performed, for example, by performing image analysis on the captured image generated when the customer takes out the product or before and after the customer takes out the product. Note that, an existing technology can be used as a technology for detecting that the product is taken out from the display place.

The generation unit 2020 also infers the product taken out from the display place. An existing technology can also be used for a technology for inferring the product taken out from the display place.

The generation unit 2020 adds product identification information of the product taken out from the display place to the inference information 200. For example, when it is detected that the product is taken out from the display place, the generation unit 2020 computes customer identification information for each of all customers included in the captured image used for the detection. The generation unit 2020 adds the product identification information of the taken-out product to the inference information 200 indicating customer identification information having a high similarity (for example, the similarity is equal to or more than a predetermined value) with the computed customer identification information. For example, in the example in FIG. 9, an imaging range of the second camera 70 includes three customers. Therefore, the product identification information of the taken-out product is added to each of pieces of the inference information 200 of these three persons.

With the method described above, the product identification information of the taken-out product is added to the inference information 200 for each of a plurality of customers who may have taken out the product from the display place. Since it is not necessary to uniquely determine a customer who has taken out the product, a processing load required for the process of adding the product identification information to the inference information 200 can be reduced. This method is useful in a situation in which the customer who takes out the product cannot always be uniquely determined. For example, a case where the second camera 70 images the customer from behind can be considered.

However, the generation unit 2020 may uniquely determine the customer who have taken out the product and add the product identification information to the inference information 200 on the customer. According to this method, the customer and the product inferred to be purchased by the customer can be associated with each other with high accuracy.

«Detection of Product Returned to Display Place»

The generation unit 2020 may detect that the customer returns the product to the display place, and reflect the detection result in the inference information 200. The detection is performed by using the captured image generated by the second camera 70. Here, an existing technology can be used for a technology for detecting that the product is returned to the display place and a technology for inferring the product returned to the display place.

There are various methods for reflecting it in the inference information 200 that the product is returned to the display place. For example, when the customer returns the product to the display place, the generation unit 2020 deletes the product identification information of the product returned to the display place from the inference information 200 of the customer.

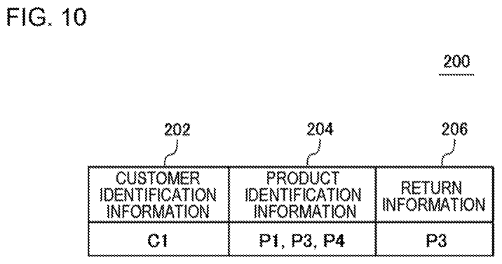

In addition, for example, the generation unit 2020 may include the product identification information of the product returned to the display place, in the inference information 200 of the customer who returns the product to the display place, in a manner which can be distinguishable from the product taken out from the display place. FIG. 10 is a diagram illustrating the inference information 200 indicating product identification information of a product returned to a display place. The inference information 200 in FIG. 10 has return information 206 in addition to the customer identification information 202 and the product identification information 204. The return information 206 indicates product identification information of a product returned to a display place.

In the example in FIG. 10, the product having the product identification information of P3 (hereinafter, product P3) is included in both the product identification information 204 and the return information 206. This means that the customer takes out the product P3 from the display place and then returns the product P3 to the display place.

Here, the generation unit 2020 does not need to uniquely determine the customer who returns the product to the display place, in the same manner as the customer who takes out the product from the display place. Specifically, when the generation unit 2020 detects that the product is returned to the display place by using a captured image generated by the second camera 70, each customer included in the captured image is handled as a customer who returns the product to the display place. For example, the generation unit 2020 deletes the product returned to the display place, from the inference information 200 of each customer included in the captured image in which it is detected that the product is returned to the display place. In addition, for example, the generation unit 2020 includes the product identification information of the product returned to the display place, in return information of the inference information 200 of each customer included in the captured image in which it is detected that the product is returned to the display place.

Note that, after the customer returns a product to the display place, the product may be taken out from the display place again. In a case where the inference information 200 has a structure in which the return information 206 is included (that is, in a case where the product identification information of the product returned to the display place is deleted from the inference information 200), for example, the generation unit 2020 adds the product identification information of the product taken out from the display place to the inference information 200 again. On the other hand, the inference information 200 has a structure in which the return information 206 is not included, for example, the generation unit 2020 adds the product identification information of the product taken out from the display place to the product inference information 200.

«About Product cannot be Uniquely Identified»

In some cases, a product taken out from a display place or a product returned to a display place cannot be uniquely identified. For example, if there is a product similar in appearance to a product taken out from a display place, even if a captured image including the product taken out from the display place is analyzed, only that one of a plurality of products similar to each other is taken out is known and product identification information of the product taken out from the display place cannot be identified. The same applies to the product returned to the display place.

In order to deal with such a case, for example, the plurality of products having appearances similar to each other are registered in the product database 120 in advance as a similar product group. For example, in a case where appearances of milk packs A, B, and C are similar to each other, as information indicating the similar product group, product identification information of each of the milk packs A, B, and C and similar product group identification information of these products are associated and registered in the product database 120 in advance. The similar product group identification information is identification information which is common to all products in the similar product group, and can be distinguished as one of the similar product group, but cannot be uniquely identified. The similar product group identification information is, for example, information on a shape and a color of the product. A plurality of similar product groups may be registered in the product database 120.

In a case where a product taken out from a display place cannot be uniquely identified and there is a similar product group including the product, the generation unit 2020 adds pieces of product identification information of all products included in the similar product group to the inference information 200. For example, in a case where the generation unit 2020 cannot uniquely identify the product taken out from the display place and the product belongs to the similar product group, customer identification information is computed for each of all the customers included in a captured image in which the product is detected. The generation unit 2020 adds pieces of product identification information of all products belonging to the similar product group to which the taken-out product belongs, to the inference information 200 indicating customer identification information having a high similarity (for example, the similarity is equal to or more than a predetermined value) with the computed customer identification information. For example, in the example in FIG. 9, an imaging range of the second camera 70 includes three customers. Therefore, the pieces of product identification information of all the products belonging to the similar product group, to which the taken-out product belongs, are added to each of pieces of the inference information 200 of these three persons. The same applies to a case where a product returned to the display place cannot be uniquely identified and there is a similar product group including the product.

<Control of Selection Image 30 in S104>

The display control unit 2040 uses a plurality of pieces of inference information 200 to display the selection image 30 on the display apparatus 20 used for a product registration work for a target customer (S104). To do so, for example, by using the plurality of pieces of inference information 200, for each product indicated in the inference information 200, the display control unit 2040 computes an evaluation value indicating a probability of the product being purchased by a target customer. As the product has the higher probability of being purchased by the target customer, the larger evaluation value is computed. A method of computing the evaluation value will be described below.

The display control unit 2040 controls display of the selection image 30 on the display apparatus 20 based on the evaluation value of each product. For example, the display control unit 2040 determines the selection image 30 of which product is to be displayed on the display apparatus 20, by using the evaluation value. Here, it is assumed that the number of selection images 30 which can be displayed on the display apparatus 20 is n (n is a positive integer). In this case, the display control unit 2040 causes the display apparatus 20 to display the selection image 30 of each product having an evaluation value within the top n. By doing so, the product which is likely to be purchased by the target customer is displayed on the display apparatus 20.

For example, in the example in FIG. 1, the number of selection images 30 displayed on the display apparatus 20 is nine. Therefore, the display control unit 2040 causes the display apparatus 20 to display the selection image 30 for each of nine types of products from the product having the largest evaluation value to the product having the ninth largest evaluation value.

In addition, for example, the display control unit 2040 determines a layout of the selection image 30 of each product based on the evaluation value. For example, it is assumed that priorities are assigned in advance to each of a plurality of display positions at which the selection image 30 can be displayed on the display apparatus 20. For example, a display position which is easy for a person who operates the display apparatus 20 to operate or a display position which is easy to see is assigned a higher priority. Hereinafter, information indicating the priority of each display position is referred to as layout information.

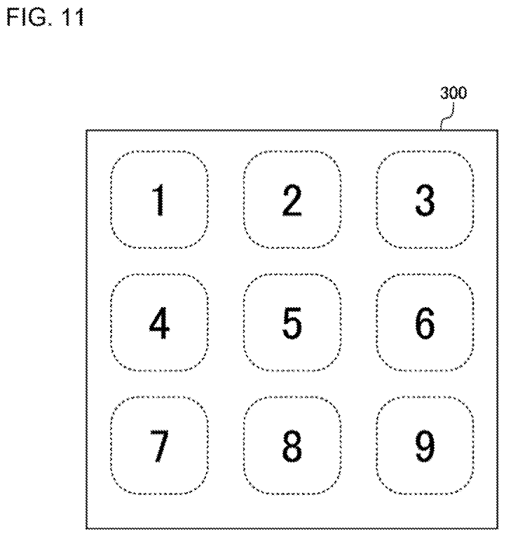

FIG. 11 is a diagram illustrating a priority of each display position defined by layout information. In a case of using layout information 300 in FIG. 11, the display control unit 2040 displays the selection image 30 of a product having the largest evaluation value at a display position labeled “1”. In the same manner, the display control unit 2040 displays the selection image 30 of a product having the second largest evaluation value at a display position labeled “2”.

Based on the evaluation value of each product for displaying the selection image 30 on the display apparatus 20 and the priority of each display position indicated in the layout information 300, the display control unit 2040 associates the selection image 30 with each display position. Specifically, the selection image 30 of the product having a larger evaluation value is associated with the display position having a higher priority. By doing so, on the display apparatus 20, the product having the higher probability of being purchased by the target customer is displayed in a location having better operability and visibility. Therefore, a work burden on a person who performs the product registration work can be reduced.

<Acquisition of Selection Image 30>

The display control unit 2040 acquires the selection image 30 for each product of which the selection image 30 is to be displayed on the display apparatus 20. For example, when the tea A is selected as the product for displaying the selection image 30 on the display apparatus 20, the display control unit 2040 acquires the selection image 30 of the tea A.

An existing technology can be used as a technology for acquiring the selection image 30 for each product. For example, the selection image 30 of the product is stored in advance in the product database 120 in association with product identification information of the product. When determining the product for which the selection image 30 is to be displayed on the display apparatus 20, the display control unit 2040 searches the product database 120 for the product identification information of the product to acquire the selection image 30 of the product.

<Method of Computing Evaluation Value>

The display control unit 2040 computes an evaluation value of the product by using the plurality of pieces of inference information 200. A method of computing the evaluation value will be specifically described below. Among the methods to be described below, only one of the methods may be used, or any two or more may be used. In a case of using a plurality of methods, as will be described below, a total evaluation value is computed by using each evaluation value computed by the plurality of methods, and the selection image 30 is controlled to be displayed based on the total evaluation value.

«Method 1»

In this method, a target customer is imaged when a product registration work is performed. The display control unit 2040 computes an evaluation value of a product by using the imaging result. Therefore, as a premise, it is assumed that a camera which images the target customer is installed near a place at which the product registration work is performed (a place at which the product registration apparatus 10 is installed). Hereinafter, this camera is referred to as a third camera.

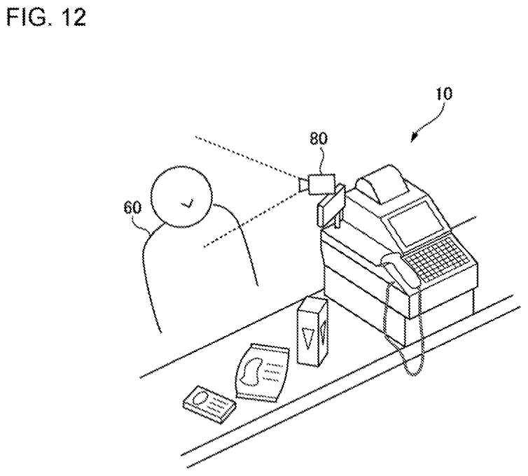

FIG. 12 is a diagram illustrating a third camera 80 installed near the product registration apparatus 10. Note that, in FIG. 12, the target customer is represented by reference numeral 60. The third camera 80 is preferably installed so as to capture an image of the customer in the approximately same direction as the first camera 50. Note that, a plurality of third cameras may be installed and the customer 60 may be imaged in a plurality of directions.

The display control unit 2040 uses the captured image generated by the third camera 80 to generate customer identification information of the target customer. Further, the display control unit 2040 computes, for each of the plurality of pieces of inference information 200, a similarity between customer identification information indicated by the inference information 200 and the customer identification information of the target customer. The display control unit 2040 uses the computed similarity to compute an evaluation value for each product indicated by the plurality of pieces of inference information 200. Note that, the “product indicated by the inference information 200” means a product of which product identification information is indicated by the inference information 200.

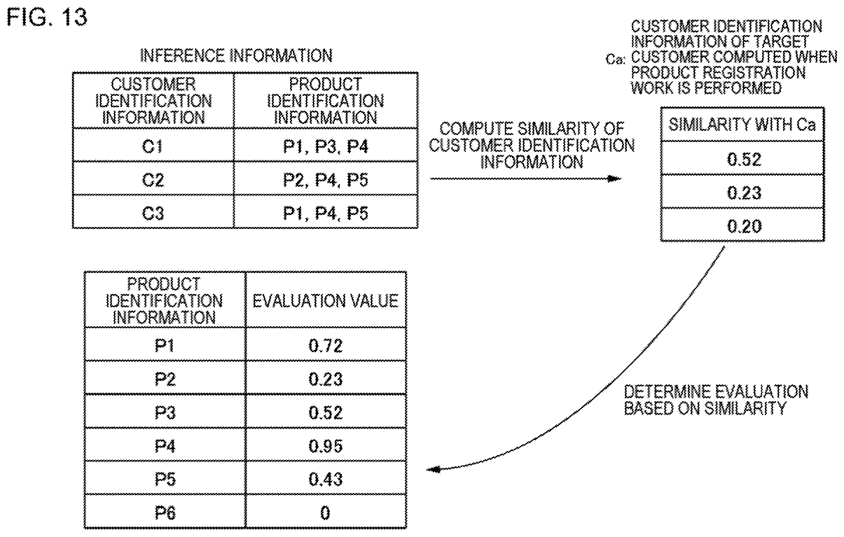

For example, the display control unit 2040 sets the similarity computed for inference information 200 as the evaluation value of each product indicated by the inference information 200. FIG. 13 is a diagram illustrating an evaluation value of a product computed by using a similarity of customer identification information. In this example, three pieces of inference information 200 are stored in the inference information storage unit 40. Note that, here, in order to facilitate illustration, the plurality of pieces of inference information 200 are collected in one table.

Each of the three pieces of inference information 200 indicates customer identification information C1, C2, and C3. Note that, in the following description, a customer of which customer identification information is Cn (n is any integer) is called a customer Cn. In the same manner, a product of which product identification information is Pm (m is any integer) is called a product Pm. Note that, in order to avoid a complicated description, products P1 to P6 are all products which can be purchased in a store.

The display control unit 2040 analyzes the captured image generated by the third camera 80 imaging the target customer. As a result, it is assumed that customer identification information called Ca is generated. The display control unit 2040 computes a similarity between the generated customer identification information Ca and the customer identification information indicated by each piece of inference information 200. Similarities computed for the three pieces of inference information 200 are respectively 0.52, 0.26, and 0.20. Therefore, the display control unit 2040 determines an evaluation value of each product based on the computed similarities. For example, the evaluation value of each of the products P1, P3, and P4 associated with the customer identification information C1 is set to 0.52.

Here, the product identification information of a product may be indicated in the plurality of pieces of inference information 200. For example, in the example in FIG. 13, the product P1 is indicated in both the inference information 200 indicating the customer identification information C1 and the inference information 200 indicating the customer identification information C3. In this case, there are a plurality of candidates for the evaluation value for the product indicated in the plurality of pieces of inference information 200.

Then, the display control unit 2040 determines the evaluation value of the product by using, for example, the plurality of candidates of the computed evaluation value. For example, the display control unit 2040 sets the maximum value of the plurality of candidates of the evaluation value as the evaluation value of the product. In the example in FIG. 13, of candidates 0.52 and 0.20 for the evaluation value of the product P1, the maximum value 0.52 is set to the evaluation value of the product P1. In addition, for example, the display control unit 2040 may use a value obtained by adding the plurality of candidates for the evaluation value as the evaluation value of the product.

Note that, as described above, the inference information 200 may indicate a list (return information) of product identification information of a product which may have been returned to a display place by a customer. In this case, the display control unit 2040 may compute an evaluation value of the product in consideration of the return information.

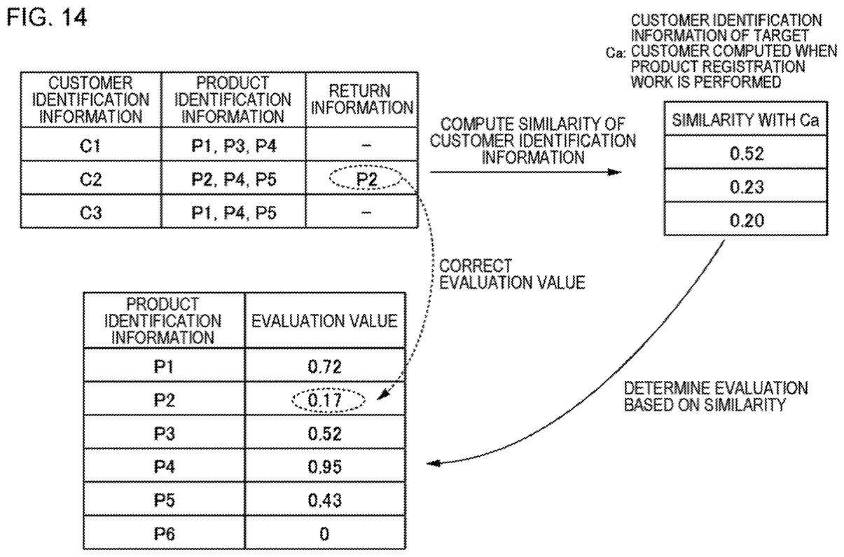

For example, the display control unit 2040 corrects the evaluation value of the product indicated by the return information by multiplying the evaluation value computed by the method described above by a predetermined value smaller than 1 (for example, 0.75). FIG. 14 illustrates a case where the inference information 200 includes return information in the example illustrated in FIG. 13. In this example, the return information of the inference information 200 indicating the customer identification information C2 indicates the product P2. Therefore, an evaluation value of the product P2 is corrected from 0.23 to 0.17 (0.23*0.75).

Further, the display control unit 2040 may correct an evaluation value of each product of which the evaluation value is computed, based on a correlation between an attribute of the product and an attribute of the customer. Specifically, the display control unit 2040 computes a probability that the customer purchases the product based on the correlation between the attribute of the product and the attribute of the customer. For example, it is assumed that a certain type of product includes a plurality of products with different amounts of money, and that younger people has a higher tendency to purchase inexpensive products. In this case, for this type of product, it can be said that there is a negative correlation between a price of the product and an age of the customer. Therefore, for this type of product, the younger the customer, the higher probability that an inexpensive product is purchased.

Therefore, for example, a prediction model is generated by using a sales record of “an attribute of customer and an attribute of a product purchased by the customer” as training data. This prediction model acquires, for example, an attribute of a customer and an attribute of the product as inputs, and outputs a probability that the customer purchases the product.

By using the prediction model, the display control unit 2040 computes, for each customer, a probability that the customer purchases the product, for each product of which an evaluation value is computed by the method described above. The display control unit 2040 corrects an evaluation value by multiplying the evaluation value computed by the method described above by the probability obtained from the prediction model.

Various models such as a neural network and a support vector machine (SVM) can be used as the prediction model. For example, the prediction model is configured to, based on a correlation coefficient or a cosine similarity computed between an attribute of a customer and an attribute of a product, compute a probability that the customer will purchase the product.

As the attribute of the customer, for example, a sex, an age, a height, clothes, a bag size, or a visit time can be used. Further, as the attribute of the product, for example, a type, a price, a weight, a package color, calories, or the like of the product can be used.

«Method 2»

In this method, the display control unit 2040 acquires a captured image generated by imaging a product to be registered by a product registration work before the registration, and computes an evaluation value of the product by using the captured image. In order to generate the captured image, a camera (hereinafter, referred to as a fourth camera) which captures the product to be registered in the product registration work is installed near the product registration apparatus 10.

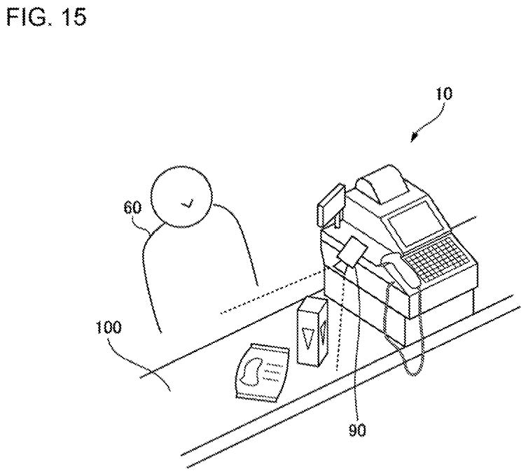

For example, the product to be registered in the product registration work is placed at a cashier counter or the like which is installed side by side with the product registration apparatus 10. Therefore, the fourth camera is set so that, for example, the cashier counter is included in an imaging range. FIG. 15 is a diagram illustrating a fourth camera for capturing an image of a product to be registered by a product registration work. In FIG. 15, a fourth camera 90 images the product placed on a cashier counter 100.

The display control unit 2040 computes a feature value of each product included in a captured image generated by the fourth camera 90, and uses the computed feature value to determine an evaluation value of the product. There are various methods. For example, the display control unit 2040 identifies a product included in the captured image by searching the product database 120 with the computed feature value. The display control unit 2040 assigns the evaluation value to the identified product. In a case where the evaluation value of the product is set to a value equal to or more than 0 and equal to or less than 1, for example, the display control unit 2040 assigns a maximum evaluation value of “1” to the identified product. However, the evaluation value to be assigned to the identified product does not necessarily have to be the maximum evaluation value.

Here, an existing technology can be used as a technology for identifying the product included in the captured image. For example, in the product database 120, product identification information (such as an identification number) of the product is stored in association with a feature value of the product. The display control unit 2040 acquires the product identification information of the product by searching the product database 120 with the feature value of the product computed from the captured image. By doing this, the product is identified.

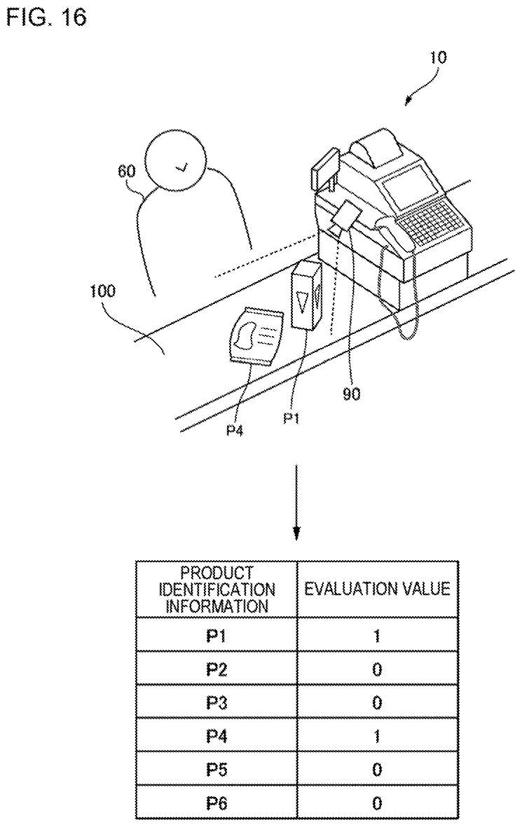

FIG. 16 is a diagram illustrating an evaluation value computed by using a captured image generated by the fourth camera 90. Each inference information 200 in FIG. 16 has the same manner as each inference information 200 in FIG. 13. It is assumed that the captured image generated by the fourth camera 90 includes the products P1 and P4. Therefore, an evaluation value of 1 is given to each of the products P1 and P4.

Note that, when searching a product database with a feature value of the product, not all products stored in the product database 120 may be set as a search range, but some of the products may be set as a search range. For example, the display control unit 2040 may exclude a product which is not indicated in any piece of the estimation information 200 from the search range. However, at this time, the display control unit 2040 may include a product recognized by using short-range wireless communication, which will be described below, in the search range even if the product is not included in the inference information 200. That is, the product included in any one or more pieces of the inference information 200 and the product recognized by using the short-range wireless communication are set as the search range products. By narrowing down the products as the search range to some products in this manner, a time required to search the product database 120 can be shortened.

«Method 3»

In this method, a product to be registered by a product registration work is recognized by using short-range wireless communication before the registration. The display control unit 2040 uses the recognition result to compute an evaluation value of the product. As a premise, an apparatus (for example, an RFID reader) for recognizing the product by using the short-range wireless communication is installed near a place at which the product registration work is performed (a place at which the product registration apparatus 10 is installed). In the following, in order to make a description easier to understand, the description is based on a situation that “RFID tags are attached to at least a part of products, and the products can be identified by using an RFID reader”. However, a method of recognizing the product by using the short-range wireless communication is not limited to the method of using the RFID reader and the RFID tag. Note that, the RFID tag is a device which stores information which can be read by the RFID reader. Specifically, the RFID tag attached to a product stores product identification information of the product.

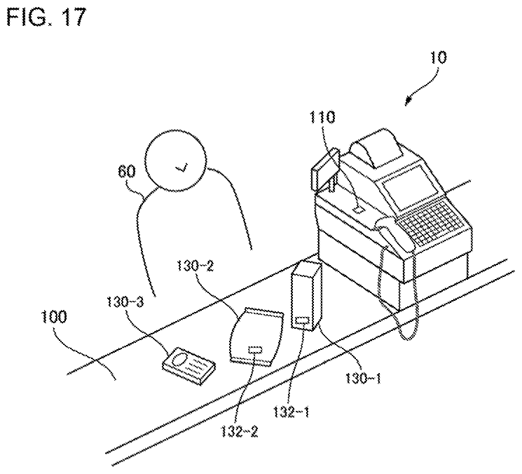

FIG. 17 is a diagram illustrating an RFID reader 110 installed near the product registration apparatus 10. The RFID reader 110 reads a product identifier of a product 130 to which an RFID tag 132 is attached by communicating with the RFID tag 132 existing around the product registration apparatus 10. In the example in FIG. 17, an RFID tag 132-1 is attached to a product 130-1, and an RFID tag 132-2 is attached to a product 130-2. The information processing apparatus 2000 can recognize that the product 130-1 exists in response to the RFID tag 132-1 being read by the RFID reader 110. In the same manner, the information processing apparatus 2000 can recognize that the product 130-2 exists in response to the RFID tag 132-2 being read by the RFID reader 110. On the other hand, the RFID tag is not attached to the product 130-3. Therefore, a method using the RFID reader 110 does not recognize existence of the product 130-3.

The display control unit 2040 determines an evaluation value for each product recognized by using the RFID reader 110. For example, the display control unit 2040 assigns a predetermined evaluation value to the recognized product. In a case where the evaluation value of the product is set to a value equal to or more than 0 and equal to or less than 1, for example, the display control unit 2040 assigns a maximum evaluation value of “1” to the identified product. However, the evaluation value to be assigned to the identified product does not necessarily have to be the maximum evaluation value.

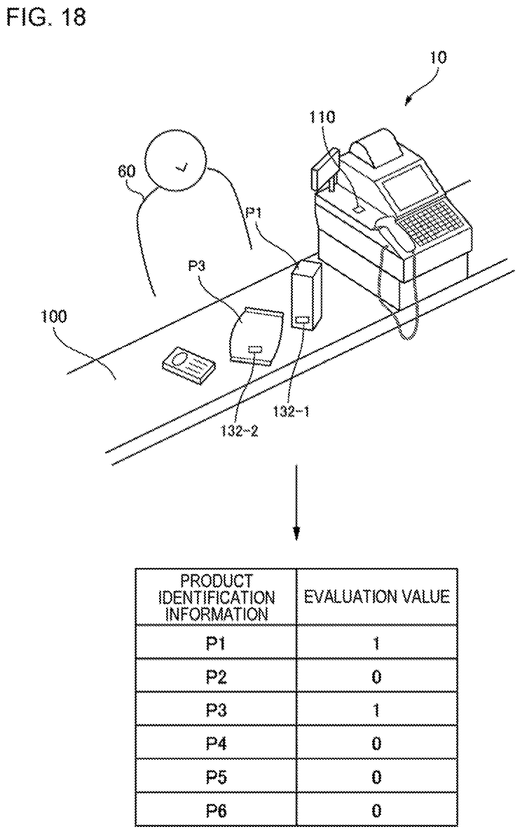

FIG. 18 is a diagram illustrating a method of determining an evaluation value by using the RFID reader 110. In FIG. 18, in the same manner as in FIG. 17, the RFID tags 132 are attached to two among three products. By respectively reading the RFID tag 132-1 and the RFID tag 132-2 with the RFID reader 110, the products P1 and P3 are recognized. Therefore, an evaluation value of 1 is given to each of the products P1 and P3.

«Method Using Plurality of Evaluation Values»

The display control unit 2040 may compute an evaluation value of each product by using a plurality of methods described above for computing the evaluation value. For example, the evaluation values computed by Methods 1 to 3 are respectively referred to as a first evaluation value to a third evaluation value, and a comprehensive evaluation value used by the display control unit 2040 to determine the selection image 30 to be displayed on the display apparatus 20 is called a total evaluation value.

The display control unit 2040 computes the total evaluation value by using the first evaluation value to the third evaluation value. The display control unit 2040 controls display of the selection image 30 on the display apparatus 20 by treating the total evaluation value computed for each product as an evaluation value of the product. Specifically, the selection image 30 of a product having a large total evaluation value is preferentially displayed on the display apparatus 20, or a layout of the selection image 30 is determined based on a size of the total evaluation value.

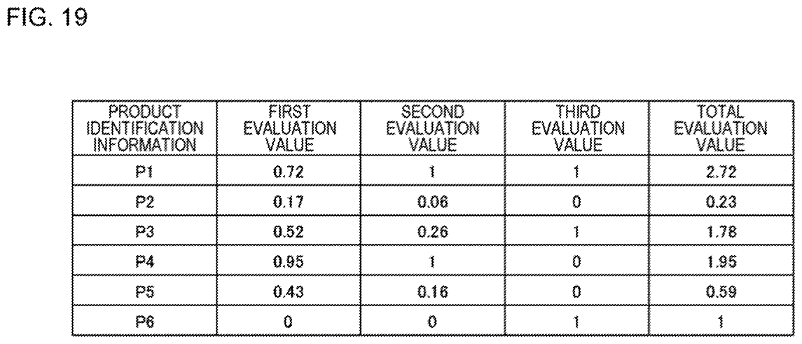

Any method of computing the total evaluation value is used. For example, the display control unit 2040 computes the total evaluation value by adding up from the first evaluation value to the third evaluation value. FIG. 19 is a diagram illustrating a total evaluation value computed by adding up from a first evaluation value to a third evaluation value. For example, a total evaluation value of the product P1 is 2.72, which is a sum of “first evaluation value=0.72”, “second evaluation value=1”, and “third evaluation value=1”.

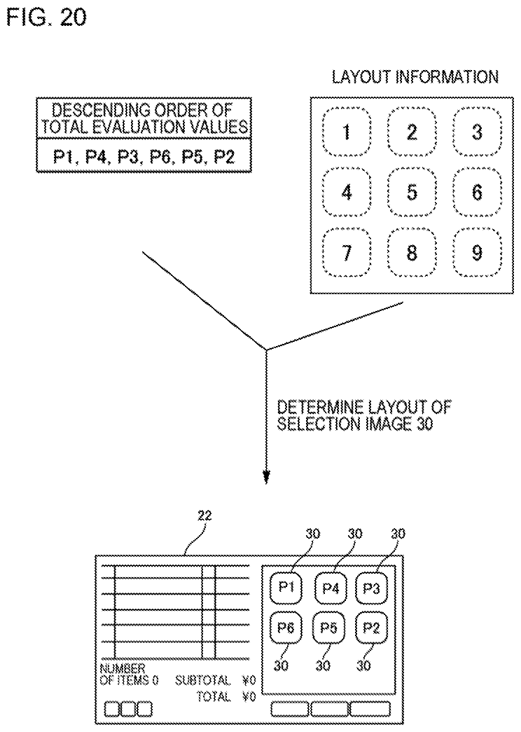

FIG. 20 is a diagram illustrating display of the selection image 30 controlled based on the total evaluation value illustrated in FIG. 19. The touch panel 22 is a touch panel provided on the display apparatus 20. In this example, the display control unit 2040 determines a layout of the selection image 30 according to the layout information 300 illustrated in FIG. 20.

Here, when the products are arranged in descending order of the total evaluation values, the products are “P1, P4, P3, P6, P5, and P2”. The display control unit 2040 matches this order with the layout information 300. As a result, the layout of the selection image 30 is as illustrated in FIG. 20. Note that, the selection image 30 displayed as Pn (n is an integer) represents the selection image 30 of the product Pn.

Further, the display control unit 2040 may correct an integrated value of the first evaluation value to the third evaluation value and use the corrected value as the total evaluation value. For example, the display control unit 2040 uses a correlation between an attribute of a customer and an attribute of the product. Specifically, the display control unit 2040 computes, for each customer, a probability that the customer purchases the product, for each product of which an evaluation value is computed. The display control unit 2040 sets a value obtained by multiplying the integrated value of the first evaluation value to the third evaluation value by this probability as the total evaluation value. Note that, a method of computing the probability that the customer purchases the product with the correlation between the attribute of the customer and the attribute of the product is as described above.

### Example Embodiment 2

A functional configuration of the information processing apparatus 2000 according to Example Embodiment 2 is represented in, for example, FIG. 2 in the same manner as the information processing apparatus 2000 according to Example Embodiment 1.

The information processing apparatus 2000 according to Example Embodiment 2 updates display of the display apparatus 20 with progress of a product registration work. When the product registration work progresses, some of products to be purchased by a target customer are registered as settlement targets. That is, some of the products to be purchased by the target customer can be reliably identified. Therefore, the information processing apparatus 2000 updates the display of the display apparatus 20 based on information of the product reliably identified to be purchased by the target customer (that is, the product registered as the settlement target).

Specifically, the display control unit 2040 updates an evaluation value by reflecting the progress of the product registration work. The display control unit 2040 controls the display of the selection image 30 on the display apparatus 20 by the method described in Example Embodiment 1 by using the updated evaluation value. For example, the display control unit 2040 updates the display of the display apparatus 20 so that the selection image 30 of each product of which the evaluation value after the update is within the top n is displayed on the display apparatus 20. In addition, for example, the display control unit 2040 updates a layout of the selection image 30 on the display apparatus 20 by matching the updated evaluation value with the layout information 300.

More specifically, the display control unit 2040 narrows down candidates for the target customer based on the progress of the product registration work, and uses only the inference information 200 of each of the candidates after the narrowing down and recomputes a first evaluation value to update the first evaluation value. The candidates for the target customer are narrowed down based on the product registered in the product registration work. The display control unit 2040 determines the inference information 200 including the product registered in the product registration work performed on the target customer, and recomputes the first evaluation value using only the inference information 200. In other words, the inference information 200 which does not include the product registered in the product registration work performed on the target customer is excluded from the computing of the first evaluation value. The first evaluation value of each product indicated in the inference information 200 excluded by recomputing the first evaluation value becomes small.

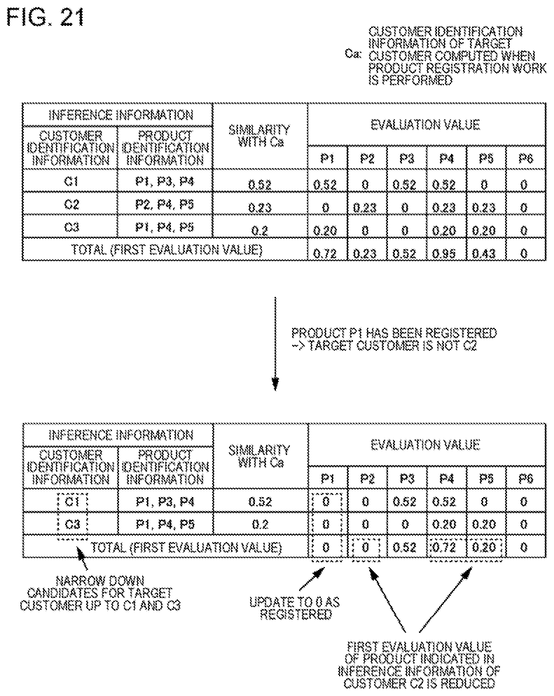

FIG. 21 is a first diagram illustrating an example of narrowing down candidates for a target customer based on progress of a product registration work for the target customer. The upper part in FIG. 21 illustrates a first evaluation value before narrowing down. Before narrowing down, the customers C1 to C3 are candidates for target customers. Therefore, the first evaluation value is computed by using the inference information 200 of the customers C1 to C3.

After that, it is assumed that the product P1 was registered in the product registration work. The product P1 is included in the inference information 200 of the customers C1 and C3, but is not included in the inference information 200 of the customer C2. From this, the candidates for the target customer are narrowed down to the customers C1 and C3.

Therefore, the display control unit 2040 recomputes the first evaluation value by using only the inference information 200 of the customers C1 and C3. The lower part in FIG. 21 illustrates the first evaluation value after recomputing. With the recomputing, the first evaluation values of the products P2, P4, and P5 included in the inference information 200 of the excluded customer C2 are reduced. In addition, the first evaluation value is 0, for the product P1 which is already registered.

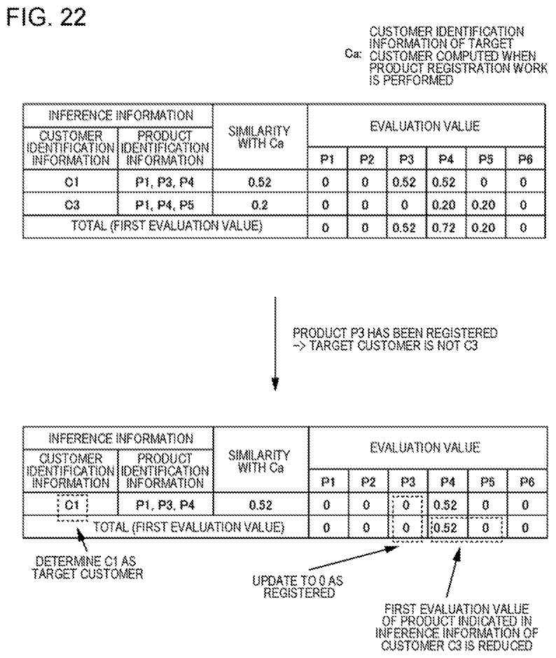

FIG. 22 is a second diagram illustrating an example of narrowing down candidates for a target customer based on progress of a product registration work for the target customer. After the situation illustrated in FIG. 21, it is assumed that the product P3 is further registered. Here, of the target customer candidates C1 and C3, only C1 has the product P3 indicated in the inference information 200. Therefore, it is confirmed that the target customer is C1.

Therefore, the display control unit 2040 recomputes the first evaluation value by using only the inference information 200 of the customer C1. The lower part in FIG. 22 illustrates the first evaluation value after recomputing. With the recomputing, the first evaluation values of the products P4 and P5 included in the inference information 200 of the customer C3 are reduced. In addition, the first evaluation value is 0, for the product P3 which has been already registered.

Note that, in a case of using a total evaluation value, the display control unit 2040 also updates the total evaluation value in response to the update of the first evaluation value by the method described above. The display control unit 2040 updates the display of the display apparatus 20 based on the updated total evaluation value.

<Product Registration Work Using RFID>

A product to which an RFID is attached may be automatically registered by reading the RFID, or may be manually registered. In the latter case, for example, the display control unit 2040 highlights (changes a color, and the like) the selection image 30 of the product of which the RFID is read. By doing so, a store clerk or the like who performs a product registration work can easily recognize the product of which the RFID is to be read. The store clerk or the like selects the highlighted selection image 30 to register the product of which the RFID is read. When the product registration is performed, an evaluation value is recomputed and the display of the display apparatus 20 is changed as described above.

<Example of Hardware Configuration>

A hardware configuration of a computer which realizes the information processing apparatus 2000 according to Example Embodiment 2 is represented by FIG. 3 in the same manner as in Example Embodiment 1, for example. Meanwhile, the storage device 1080 of the computer 1000 which realizes the information processing apparatus 2000 of the present example embodiment further stores a program module which realizes a function of the information processing apparatus 2000 of the present example embodiment.

### Advantageous Effect

With the information processing apparatus 2000 according to the present example embodiment, the display of the selection image 30 on the display apparatus 20 is updated by using a state of the product registration work for the target customer (the information related to the already registered product). When the product registration work for the target customer progresses, some of the products to be purchased by the target customer are registered as settlement targets, so that some of the products purchased by the target customer are identified. In this manner, by using the information on the product which is determined to be purchased by the target customer, it becomes possible to infer other products to be purchased by the target customer with higher accuracy. Therefore, the selection image 30 can be more appropriately displayed on the display apparatus 20, and a work load of the product registration work can be further reduced.

### Example Embodiment 3

A functional configuration of the information processing apparatus 2000 according to Example Embodiment 3 is represented in, for example, FIG. 2 in the same manner as the information processing apparatus 2000 according to Example Embodiment 1.

The information processing apparatus 2000 according to Example Embodiment 3 updates the display of the display apparatus 20 by using information related to a product registration work for customers other than the target customer. Specifically, the display control unit 2040 updates one or more of the first evaluation value and the third evaluation value described above, and updates the display of the display apparatus 20 based on the updated evaluation value. Note that, in a case where a total evaluation value is used, the total evaluation value is updated by using the updated first evaluation value and third updated evaluation value. Hereinafter, an updating method for each of the first evaluation value and the third evaluation value will be described.

«Updating First Evaluation Value»

The target customers may be narrowed down as the product registration work for the customers other than the target customer progresses. For example, at a certain point, candidates for the target customer are C1, C2, and C3. That is, it is assumed that the first evaluation value is computed by using the inference information 200 of each of the customers C1 to C3. At this time, it is assumed that a target of the other product registration work is found to be the customer C2 as the other product registration work progresses. Thus, C2 can be excluded from the candidates for the target customer, and the candidates are narrowed down to C1 and C3. Therefore, the display control unit 2040 updates the first evaluation value by recomputing the first evaluation value, by using only the inference information 200 of the customers C1 and C3.

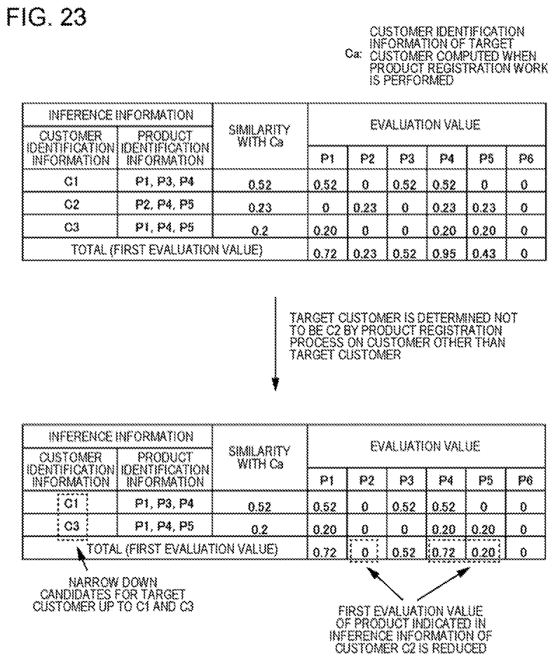

FIG. 23 is a diagram illustrating an example of narrowing down candidates for a target customer based on progress of a product registration work for a customer other than the target customer. The upper part in FIG. 23 illustrates a first evaluation value before narrowing down. Before narrowing down, the customers C1 to C3 are candidates for target customers. Therefore, the first evaluation value is computed by using the inference information 200 of the customers C1 to C3.

After that, it is assumed that the customer C2 is not the target customer according to the product registration work for the customers other than the target customer. The candidates for the target customer are narrowed down to C1 and C3.

Therefore, the display control unit 2040 recomputes the first evaluation value by using only the inference information 200 of the customers C1 and C3. The lower part in FIG. 23 illustrates the first evaluation value after recomputing. With the recomputing, the first evaluation values of the products P2, P4, and P5 included in the inference information 200 of the excluded customer C2 are reduced.

«Updating Third Evaluation Value»

For example, it is assumed that a range in which the RFID reader 110 installed on a periphery of a product registration apparatus 10 recognizes a product includes not only the cashier counter 100 of the product registration apparatus 10 but also the cashier counter 100 of a product registration apparatus 10 installed next to the product registration apparatus 10. In this case, the product recognized by the RFID reader 110 includes not only a product to be purchased by a target customer but also a product to be purchased by another customer who performs a product registration work on the adjacent product registration apparatus 10.

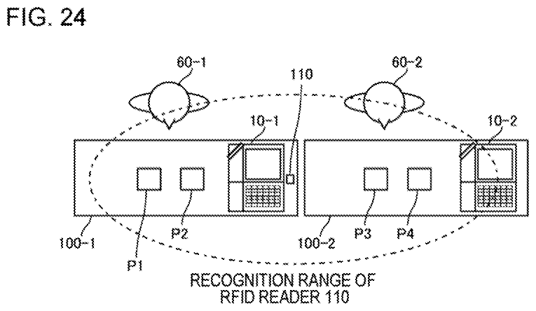

FIG. 24 is a diagram illustrating a situation in which a plurality of cashier counters 100 are included in a recognition range of the RFID reader 110. In FIG. 24, the product registration work for a customer 60-1 is performed by a product registration apparatus 10-1. On the other hand, the product registration work for the customer 60-2 is performed by a product registration apparatus 10-2. A cashier counter 100-1 and a cashier counter 100-2 are respectively provided side by side with the product registration apparatus 10-1 and the product registration apparatus 10-2. At the cashier counter 100-1, the products P1 and P2 to be purchased by the customer 60-1 are placed. Further, the products P3 and P4 to be purchased by the customer 60-2 are placed at the cashier counter 100-2.

The recognition range of the RFID reader 110 includes two of the cashier counter 100-1 installed side by side with the product registration apparatus 10-1 and the cashier counter 100-2 installed side by side with the product registration apparatus 10-2. Therefore, if the RFID reader 110 recognizes the product when the product registration work for the customer 60-1 is started, the products P1 to P4 are recognized one by one. That is, the products P3 and P4 which the customer 60-1 does not purchase are also included in the recognition result of the RFID reader 110.

When the product registration work for the customer 60-2 proceeds in this situation, the products P3 and P4 are registered as products purchased by the customer 60-2. Here, referring to the registration result, it can be understood that the products P3 and P4 among the products recognized by the RFID reader 110 are not products to be purchased by the customer 60-1.

Therefore, the information processing apparatus 2000 according to Example Embodiment 3 uses information on the product registration work performed by another product registration apparatus 10 having a predetermined relationship with the product registration apparatus 10 used for the product registration work for the target customer to update a third evaluation value of each product for the target customer. The display control unit 2040 controls the display of the selection image 30 on the display apparatus 20 by the method described in Example Embodiment 1 by using the evaluation value after the update. For example, the display control unit 2040 updates the display of the display apparatus 20 so that the selection image 30 of each product of which the evaluation value after the change is within the top n is displayed on the display apparatus 20. In addition, for example, the display control unit 2040 updates a layout of the selection image 30 on the display apparatus 20 by matching the updated evaluation value with the layout information 300.

Here, the “product registration apparatus 10 having a predetermined relationship with the product registration apparatus 10 used for the product registration work for the target customer” is the product registration apparatus 10 in which at least a part of a place (the cashier counter 100-2 in FIG. 24) at which the product which is a target of the product registration work of the product registration apparatus 10 is placed is included in a recognition range of the RFID reader 110 provided on a periphery of the product registration apparatus 10 used for the product registration work for the target customer.

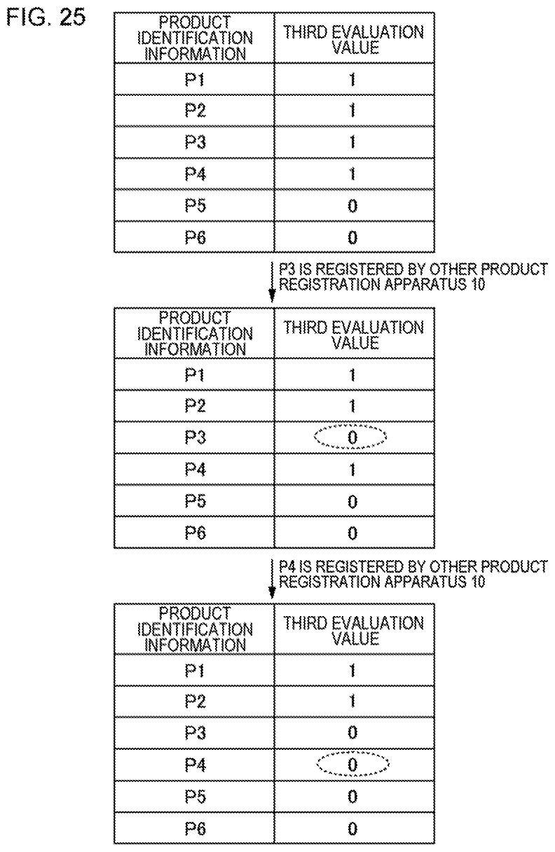

FIG. 25 is a diagram illustrating a method in which the information processing apparatus 2000 according to Example Embodiment 3 changes a third evaluation value. In FIG. 25, the information processing apparatus 2000 controls display of the selection image 30 in the product registration apparatus 10-1.

In FIG. 25, the situation illustrated in FIG. 24 is assumed. Therefore, the RFID reader 110 recognizes the products P1, P2, P3, and P4. Therefore, the information processing apparatus 2000 assigns a third evaluation value of 1 to each of the products P1 to P3.

After that, it is assumed that the product P3 is registered as a settlement target by the product registration apparatus 10-2. The information processing apparatus 2000 updates the third evaluation value of the product P3 to 0. The display of the display apparatus 20 is updated by using the corrected evaluation value.

Further, after that, it is assumed that the product P4 is registered as a settlement target by the product registration apparatus 10-2. The information processing apparatus 2000 updates the third evaluation value of the product P4 to 0. The display of the display apparatus 20 is updated by using the corrected evaluation value.

«Total Evaluation Value»

In a case of using a total evaluation value, the display control unit 2040 also updates the total evaluation value in response to the update of the first evaluation value or the third evaluation value as described above. The display control unit 2040 updates the display of the display apparatus 20 based on the updated total evaluation value.

<Example of Hardware Configuration>

A hardware configuration of a computer which realizes the information processing apparatus 2000 according to Example Embodiment 3 is represented in FIG. 3 in the same manner as in Example Embodiment 1, for example. Meanwhile, the storage device 1080 of the computer 1000 which realizes the information processing apparatus 2000 of the present example embodiment further stores a program module which realizes a function of the information processing apparatus 2000 of the present example embodiment.

### Advantageous Effect

With the information processing apparatus 2000 according to the present example embodiment, an evaluation value in the product registration apparatus 10 which performs a product registration work for a target customer is updated, based on a result of the product registration work in another product registration apparatus 10. Therefore, in the product registration apparatus 10 which performs the product registration work for the target customer, the display of the display apparatus 20 can be updated so that the selection image 30 is more appropriately displayed. Therefore, it is possible to further reduce a work load of the product registration work by using the display apparatus 20.

Although the example embodiments of the present invention are described with reference to the drawings, these are examples of the present invention, and a combination of the respective example embodiments or various other configurations other than the example embodiment described above may be adopted.

A part or all of the example embodiments may also be described as the following appendixes, but are not limited to the following.

1. An information processing apparatus including:
a generation unit that generates, based on a behavior of each of a plurality of customers, inference information in which identification information of the customer and identification information of a product inferred to be purchased by the customer are associated with each other; and
a display control unit that displays selection information for registering the product as a settlement target on a display apparatus used for a product registration work of registering the product purchased by a target customer as the settlement target, by using a plurality of pieces of the inference information.

2. The information processing apparatus according to appendix 1,
in which for each product indicated in each of the plurality of pieces of inference information, the display control unit computes an evaluation value representing a level of a probability that the product is purchased by the target customer, and controls display of the selection information by using the computed evaluation value.

3. The information processing apparatus according to appendix 2,
in which when the number of pieces of selection information displayed on the display apparatus is assumed as n, the display control unit displays the selection information of each product included in a top n of an order of magnitudes of the evaluation values on the display apparatus.

4. The information processing apparatus according to appendix 2 or 3,
in which the display control unit
acquires layout information indicating a priority for each display position on the display apparatus capable of displaying the selection information, and
displays the selection information of a product having a larger evaluation value at a display position on the display having a higher priority in the layout information.

5. The information processing apparatus according to any one of appendixes 2 to 4,
in which the identification information of the customer indicated by the inference information is a feature value of the customer, and
the display control unit
computes a feature value of the target customer, from a first captured image generated by imaging the target customer when the product registration work is performed for the target customer, and
computes a similarity between the feature value of the customer indicated by the inference information and the feature value of the target customer computed by using the first captured image to determine the evaluation value of each product indicated in the inference information by using the similarity.

6. The information processing apparatus according to any one of appendix 5,
in which the identification information of the customer indicated by the inference information is a feature value of the customer, and
the generation unit computes, from a second captured image generated by imaging a display place of the product when or before and after the product is taken out from the display place, a feature value of each of the customers included in the second captured image, and includes the identification information of the product taken out from the display place in the inference information indicating the computed feature value.

7. The information processing apparatus according to appendix 6,
in which the feature value of the customer includes at least one of a feature of a front side of the customer, a feature of a back side of the customer, and a feature of an object which the customer carries.

8. The information processing apparatus according to any one of appendixes 2 or 7,
in which the display control unit
determines at least a part of products registered in the product registration work, by using a third captured image generated by imaging the product registered in the product registration work for the target customer before the registration, and
computes the evaluation value of the determined product by using a predetermined value.

9. The information processing apparatus according to any one of appendixes 2 to 7,
in which a reader is provided at a place or a periphery of the place at which the product registration work is performed for the target customer, the reader being capable of reading identification information of at least one product by using short-range wireless communication, and
the display control unit computes, by using a predetermined value, the evaluation value of the product of which the identification information is read by the reader.

10. The information processing apparatus according to any one of appendixes 2 to 9,
in which the display control unit determines a product which has been already registered in the product registration work for the target customer, corrects the evaluation value of the product, and updates the display of the selection information on the display apparatus by using the corrected evaluation value.

11. The information processing apparatus according to appendix 9,
in which a communication range of the reader includes a place at which the product registration work is performed for the target customer, and a place at which the product registration work for another customer is performed, and
the display control unit determines a product registered as a product purchased by the other customer, corrects the evaluation value of the product, and updates the display of the selection information on the display apparatus by using the corrected evaluation value.

12. A control method executed by a computer, the method including:
a generation step of generating, based on a behavior of each of a plurality of customers, inference information in which identification information of the customer and identification information of a product inferred to be purchased by the customer are associated with each other; and
a display control step of displaying selection information for registering the product as a settlement target on a display apparatus used for a product registration work of registering the product purchased by a target customer as the settlement target, by using a plurality of pieces of the inference information.

13. The control method according to appendix 11,
in which in the display control step, for each product indicated in each of the plurality of pieces of inference information, an evaluation value representing a level of a probability that the product is purchased by the target customer is computed, and display of the selection information is controlled by using the computed evaluation value.

14. The control method according to appendix 13,
in which when the number of pieces of selection information displayed on the display apparatus is assumed as n, in the display control step, the selection information of each product included in a top n of an order of magnitudes of the evaluation values is displayed on the display apparatus.

15. The control method according to appendix 13 or 14,
in which in the display control step,
layout information indicating a priority for each display position on the display apparatus capable of displaying the selection information is acquired, and
selection information of a product having a larger evaluation value is displayed at a display position on the display having a higher priority in the layout information.

16. The control method according to any one of appendixes 13 or 15,
in which the identification information of the customer indicated by the inference information is a feature value of the customer, and
in the display control step,
a feature value of the target customer is computed, from a first captured image generated by imaging the target customer when the product registration work is performed for the target customer, and
a similarity between the feature value of the customer indicated by the inference information and the feature value of the target customer computed by using the first captured image is computed to determine an evaluation value of each product indicated in the inference information by using the similarity.

17. The control method according to appendix 13,
in which the identification information of the customer indicated by the inference information is a feature value of the customer, and
the generation step, from a second captured image generated by imaging a display place of the product when or before and after the product is taken out from the display place, a feature value of each of the customers included in the second captured image is computed, and the identification information of the product taken out from the display place is included in the inference information indicating the computed feature value.

18. The control method according to appendix 17,
in which the feature value of the customer includes at least one of a feature of a front side of the customer, a feature of a back side of the customer, and a feature of an object which the customer carries.

19. The control method according to any one of appendixes 13 to 18,
in which in the display control step,
at least a part of products registered in the product registration work are determined, by using a third captured image generated by imaging the product registered in the product registration work for the target customer before the registration, and
the evaluation value of the determined product is computed by using a predetermined value.

20. The control method according to any one of appendixes 13 to 18,
in which a reader is provided at a place or a periphery of the place at which the product registration work is performed for the target customer, the reader being capable of reading identification information of at least one product by using short-range wireless communication, and
in the display control step, the evaluation value of the product of which the identification information is read by the reader is computed, by using a predetermined value.

21. The control method according to any one of appendixes 13 to 20,
in which in the display control step, a product which has been already registered in the product registration work for the target customer is determined, the evaluation value of the product is corrected, and the display of the selection information on the display apparatus is updated by using the corrected evaluation value.

22. The control method according to appendix 20,
in which a communication range of the reader includes a place at which the product registration work is performed for the target customer, and a place at which the product registration work for another customer is performed, and
in the display control step, a product registered as a product purchased by the other customer is determined, the evaluation value of the product is corrected, and the display of the selection information on the display apparatus is updated by using the corrected evaluation value.

23. A program causing a computer to execute each step of the control method according to any one of appendixes 12 to 22.

This application claims priority based on Japanese Patent Application No. 2018-096856 on May 21, 2018, the disclosure of which is incorporated herein in its entirety.

1. An information processing apparatus comprising:
a generation unit that generates, based on a behavior of each of a plurality of customers, inference information in which identification information of the customer and identification information of a product inferred to be purchased by the customer are associated with each other; and
a display control unit that displays selection information for registering the product as a settlement target on a display apparatus used for a product registration work of registering the product purchased by a target customer as the settlement target, by using a plurality of pieces of the inference information.

2. The information processing apparatus according to claim 1,
wherein for each product indicated in each of the plurality of pieces of inference information, the display control unit computes an evaluation value representing a level of a probability that the product is purchased by the target customer, and controls display of the selection information by using the computed evaluation value.

3. The information processing apparatus according to claim 2,
wherein when the number of pieces of selection information displayed on the display apparatus is assumed as n, the display control unit displays the selection information of each product included in a top n of an order of magnitudes of the evaluation values on the display apparatus.

4. The information processing apparatus according to claim 2,
wherein the display control unit
acquires layout information indicating a priority for each display position on the display apparatus capable of displaying the selection information, and
displays the selection information of a product having a larger evaluation value at a display position on the display apparatus having a higher priority in the layout information.

5. The information processing apparatus according to claim 2,
wherein the identification information of the customer indicated by the inference information is a feature value of the customer, and
the display control unit
computes a feature value of the target customer, from a first captured image generated by imaging the target customer when the product registration work is performed for the target customer, and
computes a similarity between the feature value of the customer indicated by the inference information and the feature value of the target customer computed by using the first captured image to determine the evaluation value of each product indicated in the inference information by using the similarity.

6. The information processing apparatus according to claim 5,
wherein the generation unit, when or before and after a product is taken out from a display place, includes the identification information of the product taken out from the display place in the inference information of the customer included in a second captured image generated by imaging the display place.

7. The information processing apparatus according to claim 6,
wherein the feature value of the customer includes at least one of a feature of a front side of the customer, a feature of a back side of the customer, and a feature of an object which the customer carries.

8. The information processing apparatus according to claim 2,
wherein the display control unit
identifies at least a part of products registered in the product registration work, by using a third captured image generated by imaging the product registered in the product registration work for the target customer before the registration, and
computes the evaluation value of the identified product by using a predetermined value.

9. The information processing apparatus according to claim 2,
wherein a reader is provided at a place or a periphery of the place at which the product registration work is performed for the target customer, the reader being capable of reading identification information of at least one product by using short-range wireless communication, and
the display control unit computes, by using a predetermined value, the evaluation value of the product of which the identification information is read by the reader.

10. The information processing apparatus according to claim 2,
wherein the display control unit identifies a product which has been already registered in the product registration work for the target customer, corrects the evaluation value of the product, and updates the display of the selection information on the display apparatus by using the corrected evaluation value.

11. The information processing apparatus according to claim 9,
wherein a communication range of the reader includes a place at which the product registration work is performed for the target customer, and a place at which the product registration work is performed for another customer, and
the display control unit identifies a product registered as a product purchased by the other customer, corrects the evaluation value of the product, and updates the display of the selection information on the display apparatus by using the corrected evaluation value.

12. A control method executed by a computer, the method comprising:
generating, based on a behavior of each of a plurality of customers, inference information in which identification information of the customer and identification information of a product inferred to be purchased by the customer are associated with each other; and
displaying selection information for registering the product as a settlement target on a display apparatus used for a product registration work of registering the product purchased by a target customer as the settlement target, by using a plurality of pieces of the inference information.

13. The control method according to claim 12,
wherein in the displaying, for each product indicated in each of the plurality of pieces of inference information, an evaluation value representing a level of a probability that the product is purchased by the target customer is computed, and display of the selection information is controlled by using the computed evaluation value.

14. The control method according to claim 13,
wherein when the number of pieces of selection information displayed on the display apparatus is assumed as n, in the displaying, the selection information of each product included in a top n of an order of magnitudes of the evaluation values is displayed on the display apparatus.

15. The control method according to claim 13,
wherein in the displaying,
layout information indicating a priority for each display position on the display apparatus capable of displaying the selection information is acquired, and
selection information of a product having a larger evaluation value is displayed at a display position on the display apparatus having a higher priority in the layout information.

16. The control method according to claim 13,
wherein the identification information of the customer indicated by the inference information is a feature value of the customer, and
wherein in the displaying,
a feature value of the target customer is computed, from a first captured image generated by imaging the target customer when the product registration work is performed for the target customer, and
a similarity between the feature value of the customer indicated by the inference information and the feature value of the target customer computed by using the first captured image is computed to determine an evaluation value of each product indicated in the inference information by using the similarity.

17. The control method according to claim 16,
wherein the identification information of the customer indicated by the inference information is a feature value of the customer, and
in the generating, when or before and after a product is taken out from a display place, the identification information of the product taken out from the display place is included in the inference information of the customer included in a second captured image generated by imaging the display place.

18. The control method according to claim 17,
wherein the feature value of the customer includes at least one of a feature of a front side of the customer, a feature of a back side of the customer, and a feature of an object which the customer carries.

19. The control method according to claim 13,
wherein in the displaying,
at least a part of products registered in the product registration work are determined, by using a third captured image generated by imaging the product registered in the product registration work for the target customer before the registration, and
the evaluation value of the determined product is computed by using a predetermined value.

20-22. (canceled)

23. A non-transitory computer-readable storage medium storing a program causing a computer to execute a control method comprising:
generating, based on a behavior of each of a plurality of customers, inference information in which identification information of the customer and identification information of a product inferred to be purchased by the customer are associated with each other; and
displaying selection information for registering the product as a settlement target on a display apparatus used for a product registration work of registering the product purchased by a target customer as the settlement target, by using a plurality of pieces of the inference information.
